(19) United States
(12) Patent Application Publication
(10) Pub. No.: US 2012/0299916 A1
(43) Pub. Date: Nov. 29, 2012

(54) SYSTEM AND METHOD FOR QUANTITATIVE MEASUREMENT OF CARTILAGE HEALTH USING MRI MAPPING TECHNIQUES

(75) Inventors: Johan Erik Giphart, Eagle, CO (US); Erin P. Lucas, Vail, CO (US); Charles Ho, Edwards, CO (US)

(73) Assignee: Steadman Philippon Research Institute, Vail, CO (US)

(21) Appl. No.: 13/477,968

(22) Filed: May 22, 2012

Related U.S. Application Data
(60) Provisional application No. 61/488,839, filed on May 23, 2011.

(51) Int. Cl. G06T 17/00; G06K 9/62

(52) U.S. Cl. 345/420; 345/424; 382/131

(57) ABSTRACT

This disclosure describes systems, methods, and apparatus for generating a 3D rendering of and quantitative analysis of biochemical MRI voxels corresponding to a tissue or organ of interest. Voxels corresponding to the tissue or organ of interest can be identified from anatomical MRI voxels and aligned with biochemical MRI voxels. The biochemical MRI voxels aligned with the tissue or organ of interest can be isolated and then provided to one or more modules for 3D rendering and quantitative analysis.

### PRIORITY AND RELATED APPLICATION

The present Application for Patent claims priority to Provisional Application No. 61/488,839 entitled “SYSTEM AND METHOD FOR QUANTITATIVE MEASUREMENT OF CARTILAGE HEALTH USING MRI MAPPING TECHNIQUES” filed May 23, 2011, and assigned to the assignee hereof and hereby expressly incorporated by reference herein.

### FIELD OF THE DISCLOSURE

The present disclosure relates generally to medical systems. In particular, but not by way of limitation, the present disclosure relates to systems, methods and apparatuses for visualizing and analyzing Magnetic Resonance Imaging (MRI) data.

### BACKGROUND

Traditionally, only visual loss of tissue or organ volume or macroscopic damage can be observed with traditional MRI scans. If biochemical changes associated with early tissue degeneration could be detected, this degeneration could be monitored early on and treated before further progression. Recently, new MRI quantitative mapping techniques have enabled quantitative characterization of physiologic properties of tissue and organs, thus enabling the detection of deteriorating tissue or organ health prior to actual loss of volume or macroscopic structural degradation. These techniques are very useful both in the early detection of health issues with tissue and organs and with the longitudinal following of the tissue and organ health following injury or treatment.

Furthermore, existing modules for MRI-based tissue or organ mapping are limited to single slice views of MRI mapping and quantification of the MRI data is limited to queries of a single pixel and comparison of values between pixels—there are few known methods to ascertain objective MRI mapping values This relative data thus does not indicate an absolute health of tissue or organ, nor does its store quantitative statistical data for longitudinal comparisons, and is therefore of limited clinical value. Where the literature does indicate an absolute health of target tissue relative to certain mapping values, there is no standardization of the imaging and analysis protocols used to obtain these values and thus the relationship between mapping values and health status varies widely across studies. Variations result from variances in mapping sequences, post-image analysis, and the MRI machines, to name a few.

Another aspect of MRI mapping useful in the clinical setting is the ability to compare different tissues or organs or to compare a tissue or organ's regions or zones. Regions are divisions of tissue or organ on the surface based on anatomy and zones are volumetric divisions based on tissue or organ structure. Such comparisons typically require that an MRI map be segmented or that segments be further divided into regions and/or zones. Manual segmentation is typically not feasible in a clinical setting because of the lengthy processes used.

### SUMMARY OF THE DISCLOSURE

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Some embodiments of the disclosure may be characterized as a processing module operating on a processor of a computing system and reading from and writing to a memory of the computing system. The processing module can include a first selection sub module, a segment mask sub module, an alignment sub module, an identification sub module, and a quantitative analysis sub module. The first selection sub module can be configured to select a tissue or organ of interest. The segment mask sub module can be configured to define a segment mask as a subset of anatomical MRI voxels corresponding to the tissue or organ of interest. The alignment sub module can be configured to align three-dimensional positions of the biochemical MRI voxels with three-dimensional positions of the anatomical MRI voxels. The identification sub module can be configured to identify a subset of the biochemical MRI voxels having the same three-dimensional positions as the subset of the anatomical MRI voxels. The quantitative analysis sub module can be configured to generate a quantitative description of at least a portion of the subset of the biochemical MRI voxels.

Other embodiments of the disclosure may also be characterized as a method of clinically analyzing a tissue or organ of interest in a patient's body. The method can include receiving anatomical MRI voxels from an anatomical MRI sequence of an MRI. The method can also include receiving biochemical MRI voxels from a biochemical MRI sequence of the MRI. The method can further include aligning, via a processing module, at least a portion of the anatomical MRI voxels with at least a portion of the biochemical MRI voxels. The method can additionally include selecting a tissue or organ of interest. The method can further include identifying, via the processing module, a subset of the biochemical MRI voxels that correspond to the tissue or organ of interest. The method can also include performing quantitative analysis on at least a portion of the subset of the biochemical MRI voxels.

Other embodiments of the disclosure can be characterized as a system comprising a magnetic resonance imaging (MRI) scanner and a processing module receiving data from the MRI scanner. The MRI scanner can be configured to perform an anatomical MRI sequence, perform a biochemical MRI sequence, generate anatomical MRI voxels, and generate biochemical MRI voxels. The processing module can include a segment mask sub module and a quantitative analysis sub module. The segment mask sub module can be configured to identify a three-dimensional segment mask of the anatomical MRI voxels as those of the anatomical MRI voxels corresponding to a tissue or organ of interest. The segment mask sub module can also be configured to identify a three-dimensional subset of the biochemical MRI voxels as those of the biochemical MRI voxels corresponding to the tissue or organ of interest. The quantitative analysis sub module can be configured to generate a quantitative description of at least a portion of the subset of the biochemical MRI voxels.

Yet other embodiments of the disclosure can be characterized as a non-transitory, tangible computer readable storage medium, encoded with processor readable instructions to perform a method for clinically analyzing a tissue or organ of interest in a patient's body. The method can include: (1) receiving anatomical MRI voxels from an anatomical MRI sequence of an MRI; (2) receiving biochemical MRI voxels from a biochemical MRI sequence of the MRI; (3) aligning, via a processing module, at least a portion of the anatomical MRI voxels with at least a portion of the biochemical MRI voxels; (4) selecting a tissue or organ of interest; (5) identifying, via the processing module, a subset of the biochemical MRI voxels that correspond to the tissue or organ of interest; and (6) performing quantitative analysis on the subset of the biochemical MRI voxels.

### BRIEF DESCRIPTION OF THE DRAWINGS

Various objects and advantages and a more complete understanding of the present invention are apparent and more readily appreciated by referring to the following detailed description and to the appended claims when taken in conjunction with the accompanying drawings:

FIG. 1 illustrates an MRI and computing system for quantitative and visual analysis of biochemical MRI sequences in concert with anatomical MRI sequences.

FIG. 2A illustrates one view of an exemplary 3D rendering of a subset of biochemical MRI voxels.

FIG. 2B illustrates one view of the exemplary 3D rendering of a subset of biochemical MRI voxels of FIG. 2A, but where a region of the subset is highlighted.

FIG. 3 is a photograph of a two-dimensional rendering of a subset of biochemical MRI voxels overlaid atop a two-dimensional rendering of anatomical MRI voxels.

FIG. 4 illustrates a method of clinically analyzing a tissue or organ of interest in a patient body.

FIG. 5 illustrates a line drawing of cartilage of a femur at the knee overlaid with one embodiment of regions and their defining landmarks.

FIGS. 6A and 6B illustrate 3D shaded renderings of the femur and landmarks of FIG. 5.

FIG. 7 illustrates a line drawing of cartilage of a tibia overlaid with one embodiment regions and their defining landmarks.

FIG. 8 illustrates a 3D shaded rendering of the tibia and landmarks of FIG. 7.

FIG. 9 illustrates a line drawing of cartilage of a back of a patella overlaid with one embodiment regions and their defining landmarks.

FIG. 10 illustrates a 3D shaded rendering of the patella and landmarks of FIG. 9.

FIG. 11 illustrates a line drawing of cartilage of a femoral head of the hip overlaid with one embodiment of regions and their defining landmarks.

FIGS. 12A and 12B illustrate a 3D shaded rendering of the femoral head of the hip and landmarks of FIG. 11.

FIG. 13 illustrates a line drawing of cartilage of an inside of the acetabulum overlaid with one embodiment of regions and their defining landmarks.

FIG. 14 illustrates a 3D shaded rendering of the acetabulum and landmarks of FIG. 13.

FIG. 15 shows a diagrammatic representation of one embodiment of a machine in the exemplary form of a computer system within which a set of instructions can execute for causing a device to perform or execute any one or more of the aspects and/or methodologies of the present disclosure.

### DETAILED DESCRIPTION

The present disclosure relates generally to medical systems. In particular, but not by way of limitation, the present disclosure relates to systems, methods and apparatuses for visualizing and analyzing MRI data.

The word “exemplary” is used herein to mean “serving as an example, instance, or illustration.” Any embodiment described herein as “exemplary” is not necessarily to be construed as preferred or advantageous over other embodiments.

The need exists to develop systems and methods for: (1) mapping anatomical and biochemical aspects of a patient; (2) mapping and rendering an entire tissue or organ of interest quickly and in three dimensions; (3) quantifying the mapping values over the entire tissue or organ of interest; (4) dividing the maps into three-dimensional anatomical segments, regions, and/or zones that are commonly used by surgeons; (5) quantifying the mapping values for each segment, region, and/or zone; (5) rendering certain of the mapping values in three dimensions; and (6) saving the quantitative data to a database allowing for statistical comparisons across patients as well as longitudinal follow-up within the same patient.

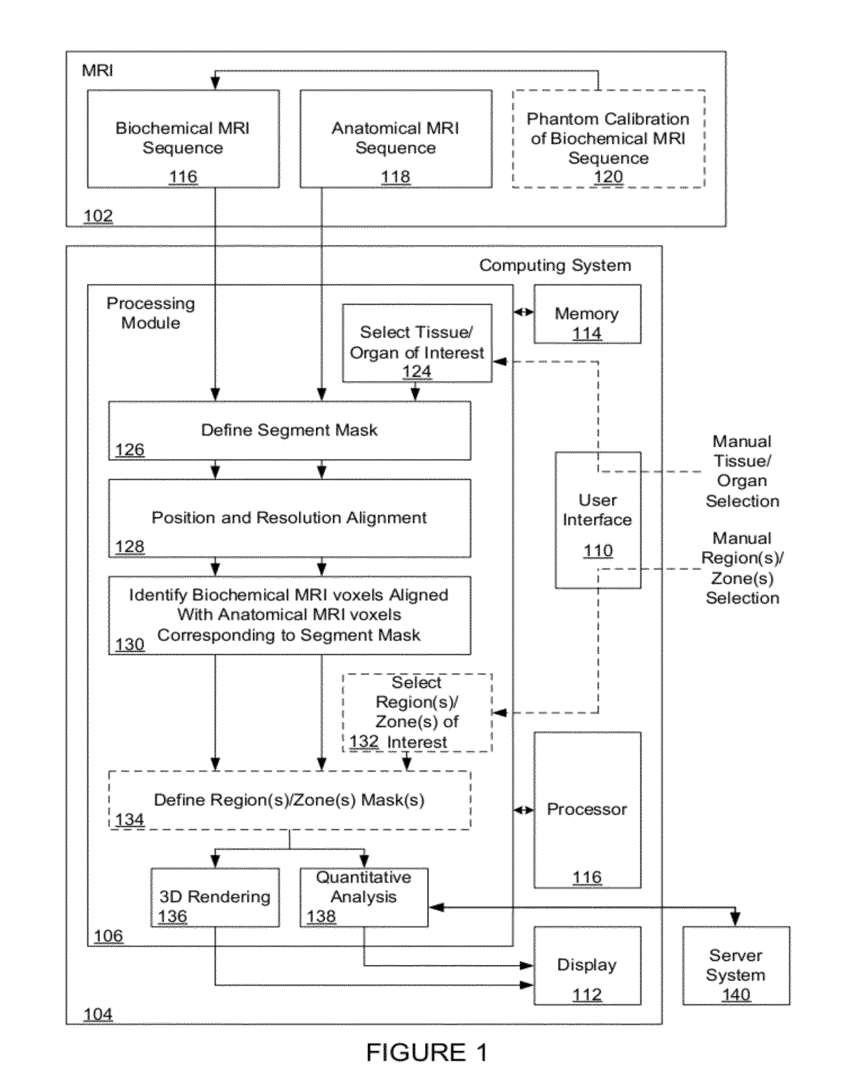

FIG. 1 illustrates an MRI and computing system for quantitative and visual analysis of biochemical MRI sequences in concert with anatomical MRI sequences. The MRI 102 can perform scans of a patient's body and then provide voxels (three-dimensional pixels) from these scans to a computing system 104 for processing. The computing system 104 can include a processing module 106 that operates on a processor 116 and writes to and reads from a memory 114. The processing module can receive user inputs via a user interface 110 and can render images and quantitative analyses to a display 112 for presentation to the user.

In particular, the MRI 102 can take an anatomical MRI sequence 118 of a patient's body to create anatomical voxels representing the patient's anatomy in three dimensions based on the anatomical MRI sequence 118. The MRI 102 can also take a biochemical MRI sequence 116 (e.g., T1, T2, T1_{ρ} mapping sequences) of the patient's body to create biochemical MRI voxels representing tissue or organ biochemical status (or health or quality) in three dimensions based on the sequence 116. The biochemical status of tissue or organ is affected by, and thus indicative of, various disease processes. In one embodiment, both sets of voxels can be derived from a single sequence. For instance, the biochemical MRI voxels can be derived from the anatomical MRI sequence 118 or the anatomical MRI voxels can be derived from the biochemical MRI sequence 116.

In the art, relationships between biochemical MRI sequence 116 values and tissue or organ health or quality are not well understood, and thus clinical use of a biochemical MRI sequence 116 is not feasible. Among other aspects, this disclosure overcomes such a challenge by proposing to use empirically-derived relationships between the values provided by the biochemical MRI sequence 116 and tissue or organ health or quality.

This begins with the anatomical MRI voxels and the biochemical MRI voxels being passed to a processing module 106 of a computing system 104, where the computing system 104 can be separate from the MRI 102, as illustrated, or included as a subsystem of the MRI 102.

The processing module 106 can be configured to process the MRI voxels, overlay the biochemical MRI voxels over the anatomical MRI voxels in terms of position and orientation, perform analyses of the biochemical MRI voxels, and/or provide outputs to a display 112 to render graphical interpretations and quantitative analyses of the MRI voxels. The quantitative analyses can also be stored to the memory 114 or a remote data store. As part of these operations, the processing module 106 or the user can select one or more tissues or organs of interest (e.g., cartilage, tendon, ligament, meniscus, labrum, or an artery) in a selection 124 sub module.

The processing module 106 can then, without assistance from the user, define a segment mask in a segment mask sub module 126. The segment mask can be defined as a subset of the anatomical MRI voxels that correspond to the tissue or organ of interest. Alternatively, the segment mask can be defined as a subset of the biochemical MRI voxels that correspond to the tissue or organ of interest, or the biochemical and anatomical MRI voxels that correspond to the tissue or organ of interest. The first selection sub module 124 can operate on one or more tissues or organs of interest, and subsequent processes can be performed on two or more tissues or organs of interest. However, for the purposes of simplicity, the remaining discussion will refer to a single tissue or organ of interest. In some instances, the segment mask sub module 126 can be partially automated, thus allowing manual input, for instance to correct the segment mask that is automatically defined. Alternatively, the segment mask sub module 126 can be manually operated in certain embodiments, for instance where the segment mask comprises a small volume (e.g., small enough that manual definition does not take more than a few minutes).

Given voxels of the segment mask corresponding to the tissue or organ of interest, the processing module 106 can then align the three-dimensional positions and orientations of the biochemical MRI voxels with the three-dimensional positions of the anatomical MRI voxels since the patient may have moved between the anatomical MRI sequence 118 and the biochemical MRI sequence 116. Such alignment can be performed by a position and resolution alignment sub module 128. Since the resolution of the anatomical MRI voxels and the biochemical MRI voxels may differ, the position and alignment sub module 128 can also modify the resolution of either or both MRI voxel sets. For instance, the biochemical MRI voxels may have lower resolution than the anatomical MRI voxels, and thus to align the resolutions, the number of anatomical MRI voxels can be reduced to coincide with the number of biochemical MRI voxels. Alternatively, the biochemical MRI voxels can be expanded in number via extrapolation algorithms (like upconversion in a TV).

The processing module 106 can then identify a subset of the biochemical MRI voxels that are aligned with the anatomical MRI voxels corresponding to the tissue or organ of interest via an identification sub module 130. In other words, the identification sub module 130 identifies a subset of the biochemical MRI voxels having the same three-dimensional positions as the subset of the anatomical MRI voxels belonging to the segment mask. For instance, if the tissue or organ of interest is the lateral meniscus, then the identification sub module 130 can identify a subset of the biochemical MRI voxels corresponding to the same three-dimensional positions as the subset of the anatomical MRI voxels that the segment mask sub module 126 identified as corresponding to the lateral meniscus.

The tissue or organ of interest can further be divided into regions and/or zones. As such, an optional second selection sub module 132 can operate on the processing module 106 and be configured to select one or more regions of interest, and/or one or more zones of interest. Like the first selection sub module 124, the second selection sub module 132 can select the one or more regions and/or zones of interest via an automated method, such as one provided by an algorithm stored in the memory 114, or the selection can be via manual user input.

An optional region(s)/zones(s) mask(s) sub module 134 can then, without input from the user, define one or more region and/or zone masks. A region and/or zone mask includes a subset of the biochemical MRI voxels and/or a subset of the anatomical MRI voxels. These subsets can be selected from the subset of biochemical MRI voxels identified in the identification sub module 130 and from the subset of anatomical MRI voxels defined by the segment mask sub module 126. In some embodiments, the optional region(s)/zone(s) mask(s) sub module 134 can be partially automated, thus allowing manual input, for instance where manual correction of the region or zone mask is desired. Alternatively, the optional region(s)/zone(s) mask(s) sub module 134 can be manually operated. For example, a user may manually define a region and/or zone where the region and/or zone is small enough that manual definition does not take more than a few minutes.

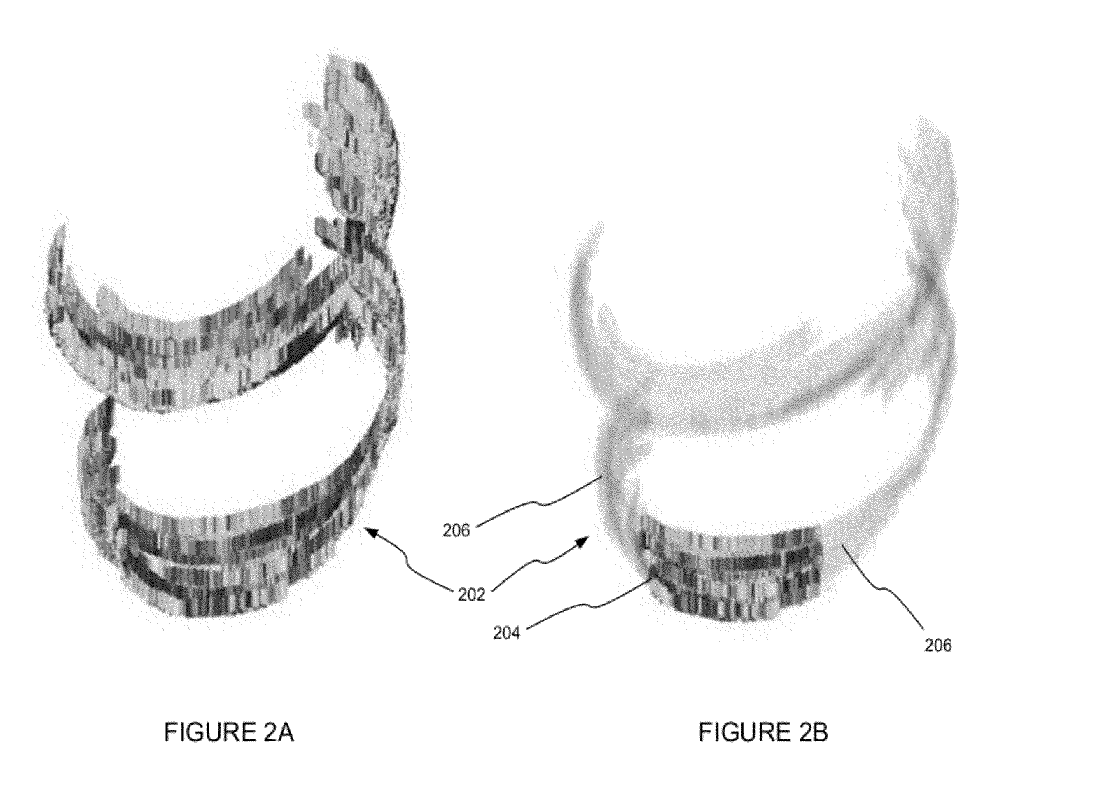

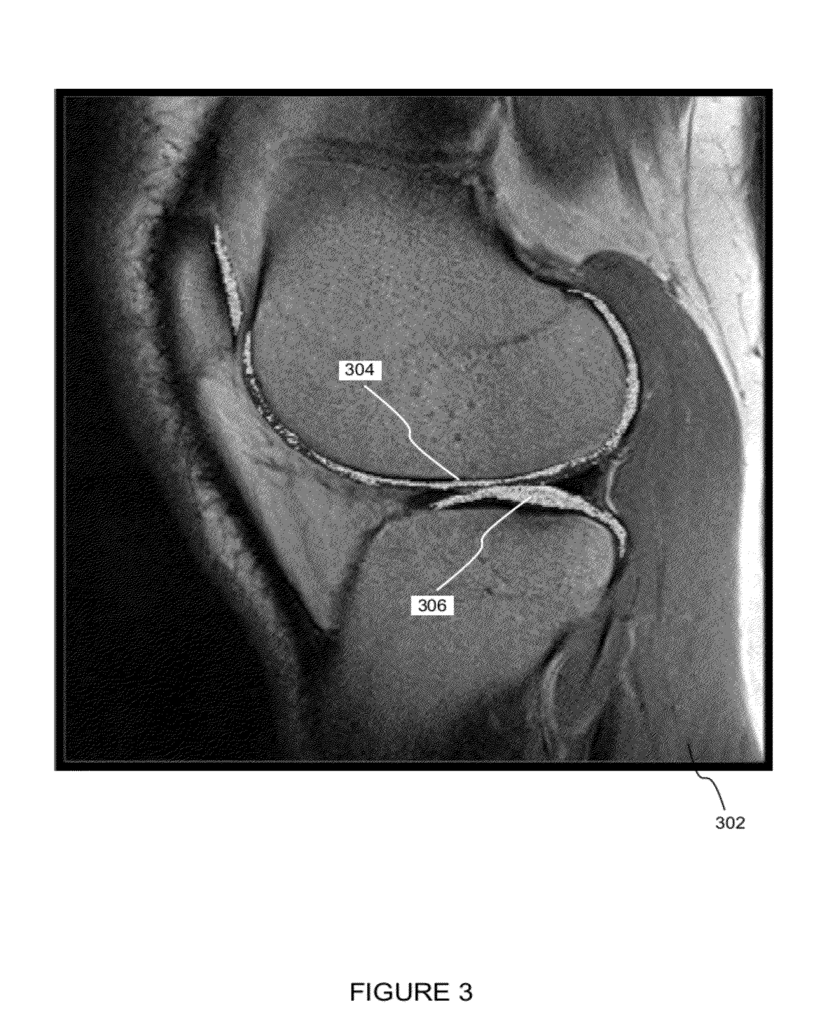

Regardless of whether region(s) and/or zone(s) of interest are selected and defined, the subsets (or subsets of subsets) are passed to a 3D rendering sub module 136. The 3D rendering sub module 136 can render the subset of the biochemical MRI voxels as a 3D model that can be moved and rotated to allow various viewpoints in real time (see FIGS. 2A and 2B). The 3D rendering sub module 136 can also render the subset of the biochemical MRI voxels overlaid atop the anatomical MRI voxels (see FIG. 3).

In some embodiments, the subset of the biochemical MRI voxels can be overlaid atop merely a portion of the anatomical MRI voxels (e.g., atop those anatomical MRI voxels corresponding to a bone) or overlaid atop reference voxels used to render a reference tissue or organ. These embodiments may be desirable where a visual reference to the rendering of the biochemical MRI voxels is desired. For instance, the biochemical MRI voxels for knee cartilage can be rendered atop a bone, but without any of the other tissue or organs of the leg being rendered.

The subsets of the biochemical and anatomical MRI voxels can also be passed to a quantitative analysis sub module 138. One purpose of quantitative analysis is to generate a quantitative description of the health or biochemical status of the tissue or organ of interest. This quantitative description can be based on the values of the biochemical voxels and/or the spatial distribution of those values in the tissue or organ of interest and in one or more regions and/or zones of interest. Data generated from the quantitative analysis can be stored in the memory 114 or in a server system 140 that is illustrated as being external to the computing system 104. The quantitative analysis sub module 138 can also access results from prior quantitative analyses stored in the memory 114 or the server system 140 and compare data between patients, between patient populations, or longitudinally between a single patient as a function of time.

FIG. 1 and the related description are exemplary only and do not portray a required order of operation for the functions exemplified by the various sub modules of the processing module 106. In other embodiments, the order of the operations herein described and illustrated can vary while not departing from the spirit of this disclosure. For instance, the optional select region(s)/zone(s) sub module 132 and the optional define region(s)/zone(s) sub module 134 can operate before or in parallel with the identification sub module 130 and/or the position and resolution alignment sub module 128.

In one embodiment, the position and resolution alignment sub module 128 operates before the first selection sub module 124 and the segment mask sub module 126. In such an embodiment, the position and resolution alignment sub module 128 may operate once while the subsequent sub modules operate a plurality of times as a user or the processing module 106 selects various tissues or organs of interest, or regions or zones of interest for comparison and analysis. In one embodiment, a plurality of tissues or organs of interest can be automatically selected and segment masks can be defined for each. A different subset of the biochemical MRI voxels can be selected for each segment mask. One or more regions and/or zones of interest can be selected and region and/or zone masks can be defined for each of the tissues or organs of interest. Quantitative analysis can then be performed on each segment mask and on each region or zone of interest. A user can then select any tissue or organ of interest, any region or zone of interest, or any combination of these in order to see a 3D rendering and quantitative analyses of the same. In this way the user can see 3D renderings and quantitative analyses of various regions, zones, and overlaps between regions and zones, as well as the same for entire tissues or organs of interest. The user may also choose to display a 3D rendering of boney anatomy along with the segment mask for visual orientation of the anatomy. In another embodiment, quantitative analysis can be performed for a tissue or organ of interest. A user can then select a region or zone of interest and see only that portion of the quantitative analysis related to the selected region or zone of interest. These are just a few of the numerous orders of operations in which the sub modules of the processing module 106 can operate.

The following discussion provides a more detailed look at various components mentioned above. The biochemical MRI sequence 116 provides values for each voxel that indicate a health or quality of the tissue or organ scanned. The biochemical MRI voxels can include values representing T2, T1, T1_{ρ}, dGemric, CEST, or DWI to name a few non-limiting examples. Each type of value represents different aspects of tissue or organ. For instance, the T2 sequence is sensitive to water content and collagen structure in the body. In some embodiments, the biochemical MRI sequence 116 can include two or more mapping sequences. For instance a T2 and a T1 sequence can be used or T2 and T1_{ρ} sequences.

In some cases, to derive the biochemical MRI voxels from the biochemical MRI sequence 116, raw data from the sequence 116 must be converted to the biochemical MRI voxels. This raw data may include a sequence of values sampled for each voxel in the patient followed by a fitting of a curve or function to the sampled values for each voxel, where a parameter of the curve or equation becomes the value for the biochemical MRI voxel. For instance, in the case of T2 values, a sequence of samples is taken after the patient is exposed to a magnetic field, which causes dipoles within the patient's body to temporarily align, and then relax again according to an exponentially-decaying time constant. The tissue is repeatedly excited with slight modifications to the imaging parameters (echo time) and the intensity value of each voxel is collected for each of these sequence variations, giving multiple data points for each voxel. The data points are then fitted with an exponential function where the fitting parameter is the exponential decay time constant, or T2. Other calculations and sequences can also be used to convert other forms of raw biochemical MRI data into the biochemical MRI voxels. Such calculations can be performed by the MRI 102 or by the processing module 106. In some cases, the computing system 104 may be a part of the MRI 102, and as such, the calculations are performed within the processing module 106 as well as within the MRI 102.

The biochemical MRI sequence 116 can be hindered by differences between MRI machines and clinical environments (e.g., humidity and temperature). The biochemical MRI sequence 116 can therefore be further tailored for clinical use (e.g., improved consistency) via use of an optional phantom calibration 120. The phantom calibration 120 can involve performing a calibration scan of one or more reference substances having known biochemical values. Once the calibration scan is performed, differences between the MRI 102 readings and known values can be used for calibration. The phantom calibration 120 thus involves both taking a calibration scan and adjusting the values of MRI voxels scanned during the biochemical MRI sequence 116. The adjustment of the MRI voxel values can take place within the MRI 102, within the computing system 104, or within both.

Both the biochemical MRI sequence 116 and the anatomical MRI sequence 118 generate voxels or values representing a volume. Voxel size can be limited or dictated by a resolution of the MRI 102 scans. For instance, the MRI 102 may be able to detect voxels of 0.8 by 0.8 by 0.8 mm or 0.3 by 0.3 by 2.0 mm. Voxel dimensions can be fixed within a given sequence, but can vary between sequences. Voxel values can be stored as matrices in the memory 114, where the voxel position in the matrix represents the voxel three-dimensional position in the patient's body or within the scanning volume from which the voxel was acquired. In some embodiments, the matrix has three-dimensions. Voxel values can be rendered as grayscale or colored values, for instance, representing different tissue in various shades of grey and different tissue or organ health in different hues of color. The volume of the patient that is scanned can vary and can include a variety of body parts such as an elbow, knee, leg, or head, to name a few.

The tissue or organ of interest can include one or more tissues or organs such as, but not limited to, a leg, a knee, or a lower portion of the femur. Manual selection can be made via the user interface 110. The user interface 110 can include a mouse, keyboard, stylus and writing pad, or touchscreen to name a few non-limiting examples. In the case of a mouse, a user may ‘click’ on a 2D or 3D image of a reference body part, such as a previously scanned knee in order to indicate which tissue(s) or organ(s) is/are of interest. Alternatively, the selection may be made on a 2D or 3D rendering of the anatomical MRI voxels. In other cases, there may be a list of body parts or boxes with the names of body parts that the user can select via the mouse. These are just a few examples of the many different ways that a user can manually select a tissue or organ of interest.

In the case of automated selection, the selection sub module 124 may access an algorithm stored in the memory 114 and use the algorithm to select a tissue or organ of interest. In some cases there may be a single tissue or organ of interest (e.g., cartilage in a knee scan) while in others the selection sub module 124 may select a plurality of tissues or organs or interest (e.g., cartilage, bone, meniscus, muscle, ligaments, and tendons of a knee).

Once the user or the processing module 106 has selected a tissue or organ of interest, the segment mask sub module 126 identifies voxels of the anatomical MRI voxels, biochemical MRI voxels, or both, corresponding to the tissue or organ of interest in a segment mask. Most commonly, the segment mask sub module 126 identifies a subset of the anatomical MRI voxels since these voxels tend to have higher resolution and better contrast than the biochemical MRI voxels. Whichever voxels the first selection sub module 124 operates upon, the selection may involve shape recognition algorithms that analyze a plurality of two-dimensional slices of the anatomical MRI voxels or one three-dimensional volume of the anatomical MRI voxels. In other embodiments, contrast analysis between adjacent pixels can be used to identify different tissues or organs. In some cases, landmarks can be identified followed by an analysis of the positions of various tissues and organs relative to the landmarks to identify different tissues and organs. In some embodiments, both shape recognition and contrast analysis can be used to identify the segment mask. The tissue or organ of interest can include a knee, hip, rotator cuff, shoulder, or ankle, to name just a few non-limiting examples.

In further embodiments, the first selection sub module 124 and the segment mask sub module 126 can make use of a hybrid of manual and automated processes. For instance, a user can be presented with a two-dimensional rendering of a slice of the anatomical MRI voxels or a previously-scanned sequence, and the user can outline or otherwise highlight the tissue or organ of interest via a touchscreen, mouse, or stylus writing on a drawing pad. The first selection sub module 124 can pass this outline or highlighting to the segment mask sub module 126, which can analyze the outline or highlighting and extend the selection into three dimensions in order to generate the segment mask. In other words, the user can provide a partial selection of the segment mask, which the segment mask sub module 126 can then use to more quickly, or perhaps more accurately, define the rest of the segment mask in three dimensions just as initial values are sometimes manually provided to nonlinear equation solvers.

Moving now to the position and resolution alignment sub module 128, while this sub module 128 has been described as performing both position and resolution alignment, in some embodiments, the position and resolution alignment sub module 128 may be configured to align position or resolution between voxels rather than both. In other embodiments, the position and resolution alignment sub module 128 can operate before the segment mask sub module 126 or in parallel therewith. In other embodiments, the position and resolution alignment sub module 128 may be the first sub module to operate in the processing module 106.

A subset of the biochemical MRI voxels can be selected by the identification sub module 130, and this subset along with the anatomical MRI voxels then have one of two routes: (1) they can pass to the optional region/zone mask sub module 134; or (2) pass to the 3D rendering sub module 136 and the quantitative analysis 138 sub module.

In the optional second selection sub module 132 and the region/zone mask sub module 134, the tissue or organ of interest can be divided according to a multitude of different methods. For instance, regions can be surface areas or volumes of the tissue or organ of interest divided up based on anatomical location or anatomical features or landmarks (e.g., the medial or lateral portion of the cartilage of the trochlear groove). Landmarks can be chosen as boney landmarks that are distinguishable during surgery and during MRI scans. Boney landmarks are also less susceptible to longitudinal variations than would be landmarks in soft tissue.

Similarly, zones can divide up a tissue or organ of interest based on structural or physiological variations. In some cases the structural or physiological variations may influence the biochemical voxel values obtained from one zone versus another. For instance, cartilage is made up of three distinct depth zones or layers based on the structural organization of the collagen. However, zones need not be layer or depth based. For instance, ligaments or musculotendinous junctions may have different bundles or layers, where each bundle or layer can be a different zone. Zones and regions can overlap where both are selected and defined.

For the purposes of this disclosure, regions may be related to anatomical location while zones may be more related to the progression of disease. In one embodiment, the second selection sub module 132 can select both a region and a zone such that the selection includes only the overlap between the region and the zone.

The one or more regions and/or zones of interest can be automatically selected via an algorithm that the second selection sub module 132 can access from the memory 114, or they can be manually selected or manually adjusted via user inputs through the user interface 110.

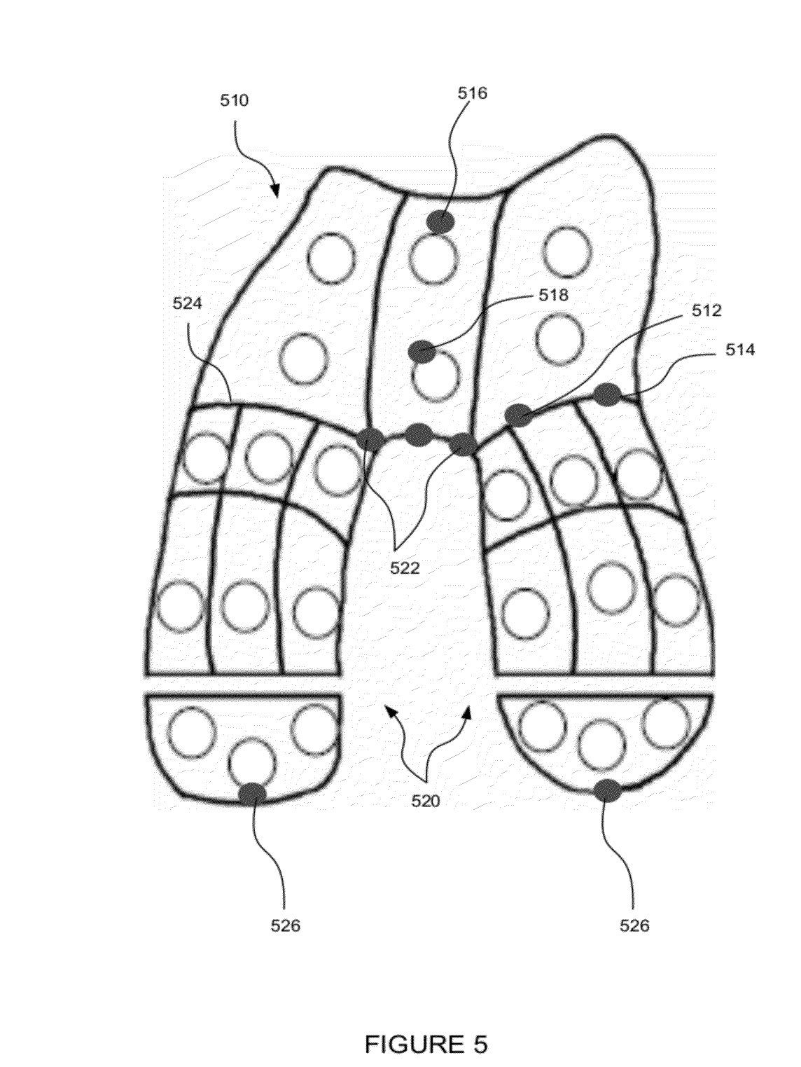

The optional region/zone mask sub module 134 can receive the biochemical MRI voxels, the subset of the biochemical MRI voxels, the anatomical MRI voxels, the subset of the anatomical MRI voxels, or some combination of these. Based on the region(s)/zone(s) of interest as selected by the second selection sub module 132, the region/zone mask sub module 134 can define one or more region masks and/or zone masks where the region and zone masks define a region or zone as two subsets of data—one subset of the subset of biochemical MRI voxels and one subset of the subset of anatomical MRI voxels. The subsets of the subsets correspond to the one or more regions and/or zones selected by the second selection sub module 132. Two subsets are thus created for each region, two for each zone, or two for each overlap between a region and a zone where one or more regions and zones are both selected. Exemplary regions will be discussed in further detail relative to FIGS. 5-16.

The 3D rendering sub module 136 can render a 3D model where the 3D model can be shaded, wireframe, or any other form of 3D rendering with the following exception: while the 3D rendering sub module 136 is capable of rendering the 3D model via one or more two-dimensional slices, such two-dimensional slices, even where there are three different two-dimensional views, are not considered renderings of the 3D model. In some embodiments, the user may also choose to display a 3D rendering of boney anatomy along with the segment mask for visual orientation of the anatomy.

The 3D rendering sub module 136 can render at least a portion of the subset of the biochemical MRI voxels to the display 112, which includes rendering a portion or all of the subset of the biochemical MRI voxels. For instance, the 3D rendering may only be performed for a specific organ, for a region (e.g., FIG. 2A) or zone or overlap in a region and a zone of the subset of biochemical MRI voxels. In cases where a region or zone is not selected, the entire subset of biochemical MRI voxels can be rendered. In other cases, different levels of grayscale tone (or color) or transparency can be used to distinguish between a region or zone and the whole subset of biochemical MRI voxels (see FIG. 2B). In other cases, at least a portion of the biochemical MRI voxels can be rendered in color while overlaid atop a grayscale rendering of the anatomical MRI voxels. In other cases, at least a portion of the biochemical MRI voxels can be rendered in a grayscale tone, or a first set of grayscale tones, that are easily distinguished from a second set of grayscale tones used to render the anatomical MRI voxels (see FIG. 3 for a two-dimensional example).

The quantitative analysis sub module 138 can perform various analyses on at least a portion of the biochemical MRI voxels as well as pass data representing the analyses to the display 112 for display to the user and/or store the data in the memory 114 or in a remote data store. The portion of the biochemical MRI voxels can include the subset of the biochemical MRI voxels or a subset of the subset of the biochemical MRI voxels. The results of the quantitative analysis can be stored in order to make comparisons between patients, patient populations, or between the same patient on different visits. In some cases comparison of prior quantitative analyses to the current data can trigger certain treatments. For instance, where the quantitative analysis sub module 138 determines that the volume of cartilage in a knee has fallen by 5%, a notification can be presented to medical staff, or medical staff can manually note the crossing of this threshold, and the medical staff can determine the appropriate action in response to the objective evidence of deteriorating health.

In one embodiment, the quantitative analysis sub module 138 can generate a histogram where each bin corresponds to a count of different values of at least a portion of the biochemical MRI voxels (e.g., T2 values or time constants). Quantitative analysis can also include determining mean and median values of at least a portion of the biochemical MRI voxels, calculating a standard deviation of at least a portion of the biochemical MRI voxels, or calculating a volume of the biochemical MRI voxels corresponding to the tissue or organ of interest (e.g., the subset of the biochemical MRI voxels).

Alternatively, quantitative analysis can include textural analysis, where differences in patterns and distribution of voxel values can be quantitatively analyzed using specialized algorithms to describe the distribution characteristics (including but not limited to contrast, variance, homogeneity, and entropy) of at least a portion of the biochemical MRI voxels. Quantitative analysis can also include calculating a volume of at least a portion of the biochemical MRI voxels, where the volume can equal a number of voxels times a volume of each voxel.

Quantitative analysis can also include analysis of the histogram or analysis of the data used to generate the histogram. For instance, different shapes of the histogram may be correlated with different tissue/organ health characteristics or the progression of diseases. Analysis may also be directed to the distribution of the histogram bins.

In other embodiments, a volume of a given value or range of values for biochemical MRI voxels, or a percentage of a segment/region/zone volume attributable to a given value or range of values, may be determined. For instance, a histogram can be generated, and one or more bins comprising one or more biochemical MRI voxel values can be summed to determine the number of voxels having one or a range of values. This sum can then be multiplied by the volume of a single voxel to arrive at a total volume of tissue or organ having the selected one or more biochemical MRI voxel values. Such embodiments could be useful for determining a volume of healthy or unhealthy tissue, or for comparing volumes of different levels of tissue quality. Any data generated in the various above-noted examples can be stored to the memory 114 or the server system 140 and/or compared to data from prior quantitative analyses for the same or a different patient or patient population stored on the server system 140.

These exemplary analyses are intended as examples only, and do not limit the scope of the various quantitative analyses that can be performed. It should be noted that the 3D rendering sub module 136 and the quantitative analysis sub module 138 can operate on either the subset of biochemical MRI voxels or the subset of the subset of biochemical MRI voxels. The quantitative analysis 138 can generate data that is passed to the display 112 for presentation to the user as graphs, numbers, tables and other presentations of data.

The processing module 106, and each of its sub modules, can be implemented as software, hardware, firmware, or a combination of the above. For instance, the segment mask sub module 126 can be implemented as an application running on the processor 116 and accessing the memory 114. Alternatively, the segment mask sub module 126 can be embodied in an ASIC. These are just two examples showing the plethora of embodiments in which the segment mask sub module and the other sub modules of the processing module 106 can be implemented.

Because the processing module 106 can be tailored to operate solely towards one or a few tissues or organs of interest (e.g., cartilage), it can also operate faster than known systems since known systems tend to be more general tools. For instance, the processing module 106 can be configured to produce 3D visualizations and/or quantitative analysis solely of cartilage or femoral cartilage, to name two non-limiting examples. The resulting increased speed allows the system illustrated in FIG. 1 to be used in clinical settings where the prior art typically is only useful in research settings (where time is much less of an issue).

The computing system 104 can operate as a standalone system in communication with the MRI 102 or as an addition to or part of the MRI 102. For instance, the processing module 106 may carry out the above-described functions via at least a processor 116 and memory 114 of the MRI 102. As a standalone system, the computing system 104 may be implemented as a desktop computer, laptop, tablet computer, smartphone, ultrabook, or netbook to name a few non-limiting examples. An external display 112 or one that is part of the MRI 102 can be used. Although illustrated as being part of the computing system 104, in some embodiments, the display 112 can be coupled to or in communication with the computing system 104.

FIG. 2A illustrates one view of an exemplary 3D rendering of a subset of biochemical MRI voxels. Here a subset of biochemical MRI voxels 202 was selected corresponding to cartilage of the knee (e.g., via the identification sub module 130). That subset of biochemical MRI voxels 202 was rendered according to the three-dimensional positions of each voxel and tone (or color) was used to indicate the value of each voxel (e.g., via the 3D rendering sub module 136). The tone represents a health or quality of the cartilage, for instance. This is just a single view of the 3D rendering, and in practice, the 3D rendering could be pivoted, moved, and rotated to change its orientation, thus providing a plurality of views of the 3D rendering.

FIG. 2B illustrates one view of the exemplary 3D rendering of a subset of biochemical MRI voxels of FIG. 2A, but where a region 204 of the subset 202 is highlighted. Here again, the subset of biochemical MRI voxels 202 was selected to correspond to cartilage of the knee. The subset 202 was again rendered, but in this illustration a region of the subset 204 has been selected and was rendered in brighter tones (or colors) than the rest of the subset 206, which was rendered in muted tones (or colors). This example shows a single region 204 being highlighted, but in other embodiments, one or more zones could be highlighted or the overlap between a region and a zone could be highlighted.

In both FIGS. 2A and 2B, the tones (or colors/shading) can be empirically correlated with a standard health or quality of the tissue or organ of interest (e.g., cartilage). As such, regardless of the patient, the MRI machine, or the region/zone of a tissue or organ of interest that is being analyzed, the tones will always correlate with the same health or quality.

FIG. 3 is a photograph of a two-dimensional rendering of a subset of biochemical MRI voxels 304, 306 overlaid atop a two-dimensional rendering of anatomical MRI voxels 302. To arrive at such an image, an anatomical and biochemical MRI sequence (e.g., anatomical MRI sequence 118 and biochemical MRI sequence 116) were carried out to produce anatomical and biochemical MRI voxels. Cartilage was selected as the tissue of interest. More particularly, femoral cartilage and cartilage of the tibia were selected. At least a portion of the anatomical and biochemical MRI voxels were aligned in terms of position and resolution. A subset of the biochemical MRI voxels were selected as those that corresponded to or aligned with the tissues of interest (cartilage). The subset of biochemical MRI voxels and the anatomical MRI voxels were presented for rendering and a slice of the biochemical MRI voxels 304, 306 were rendered overlaid atop a slice of the anatomical MRI voxels 302. The subset of biochemical MRI voxels 304, 306 were rendered in lighter tones to distinguish them from the darker tones of the anatomical MRI voxels 302. Alternatively, colored tones could have been used to render the subset of the biochemical MRI voxels 304, 306 to help visually distinguish them from the anatomical MRI voxels 302. Tones of the biochemical MRI voxels 304, 306 represent health or quality of a tissue or organ while the tones of the anatomical MRI voxels 302 help to show differences between different body parts.

The above processes could have been carried out in a variety of different orders while still arriving at the same final rendering. For simplicity and clarity, FIG. 3 was illustrated in two-dimensions, however, in practice, FIG. 3 could also be rendered in three dimensions similarly to the subset illustrated in FIGS. 2A and 2B.

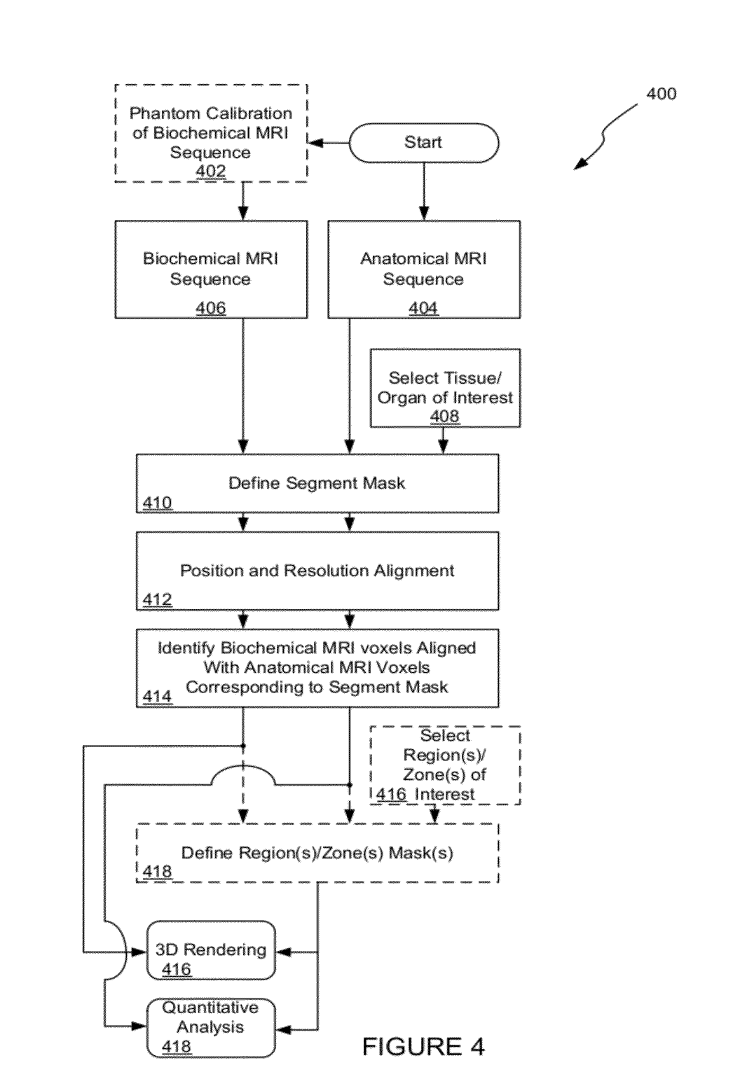

FIG. 4 illustrates a method of clinically analyzing a tissue or organ of interest in a patient body. The method 400 can optionally begin with a phantom calibration 402 where one or more MRI sequences are performed on one or more reference substances with known biochemical values. These results can then be used to calibrate the results from a biochemical MRI sequence 406. Whether this calibration is performed or not, an anatomical MRI sequence 404 and the biochemical MRI sequence 406 are performed and these generate anatomical MRI voxels and biochemical MRI voxels, respectively. A tissue or organ of interest is then selected in a first selection operation 408.

Based on this selection, a define operation 410 defines a segment mask for the tissue or organ of interest, where the segment mask includes a subset of the anatomical MRI voxels corresponding to the tissue or organ of interest. In an alternative embodiment, the segment mask can include a subset of the biochemical MRI voxels instead of a subset of the anatomical MRI voxels. In a position and resolution alignment operation 412 at least a portion of the biochemical MRI voxels can be aligned with at least a portion of the anatomical MRI voxels. This alignment can also include aligning the resolutions of either or both of the biochemical and anatomical MRI voxels. In one alternative, the position and resolution alignment operation 412 can be carried out before the first selection operation 408.

An identification operation 414 can identify biochemical MRI voxels that correspond to (e.g., align with) the subset of anatomical MRI voxels (e.g., those in the segment mask). The identification operation 414 can generate a subset of the biochemical MRI voxels. The subset of the biochemical MRI voxels and all or a subset of the anatomical MRI voxels can then be passed to the 3D rendering operation 416 and the quantitative analysis operation 418. The 3D rendering operation 416 can render to a display at least a portion of the subset of the biochemical MRI voxels (e.g., see FIGS. 2A and 2B). The quantitative analysis operation 418 can perform various operations to quantitatively present at least a portion of the subset of biochemical MRI voxels to a user (e.g., a histogram or calculation of volume of the subset).

Optionally, the subset of the biochemical MRI voxels and all or a subset of the anatomical MRI voxels can be passed to a region/zone mask operation 418. One or more regions and/or zones of interest can be selected in a second selection operation 416. The region/zone mask operation 418 can use the selected one or more regions and/or zones to generate one or more region masks, or zone masks, or masks comprising the overlapping volume of a region and a zone. The region and zone masks can include biochemical MRI voxels corresponding to the selected regions and zones. Since the regions and zones are smaller than the entire tissue or organ of interest (or segment mask), the region/zone mask operation 418 generates a subset of the subset of the biochemical MRI voxels. The subset of the subset of biochemical MRI voxels can then be provided to the 3D rendering operation 416 and the quantitative analysis operation 418 where the method 400 continues as described without the optional operations 416 and 418.

It should be noted that while this disclosure has described the anatomical MRI sequence and the biochemical MRI sequence, along with their associated voxels, as being separate processes, it is also possible for the biochemical MRI voxels to be extracted (or calculated) from the anatomical MRI sequence. In other words, in one embodiment, a single MRI sequence can generate both the biochemical MRI voxels and the anatomical MRI voxels. In such an embodiment, the sequence used can be the one previously described as the biochemical MRI sequence 116. Alternatively, the anatomical MRI voxels can be extracted (or calculated) from the biochemical MRI sequence.

It should also be noted that while automated tissue or organ of interest selection and automated segment mask creation, along with automated region/zone selection and region/zone mask creation have been discussed, in some embodiments, some or all of these operations can be manual.

FIG. 5 illustrates a line drawing of cartilage of a femur at the knee overlaid with one embodiment of regions and their defining landmarks. These regions illustrate a modification on the regions described by the International Cartilage Research Society. The main landmarks used for division into the illustrated regions are the trochlear groove, the femoral notch 522, and the terminalis sulcus. A line through a first and second point 512, 514 on the terminalis sulcus, along with top of the femoral notch 522 and a line 524 extending through the medial side in line with the top of the femoral notch 522, separate the trochlear 510 from the condyles 520. The trochlear 510 is split into three regions, medial, lateral, and central, via two lines that are drawn parallel to an imaginary line between a first superior and second inferior landmark 516, 518 indicating the deepest portion of the trochlear groove. The condyles 520 are each split into 7 regions via two vertical dividing lines and two horizontal dividing lines. The most posterior points on each condyle are indicated using landmarks 526.

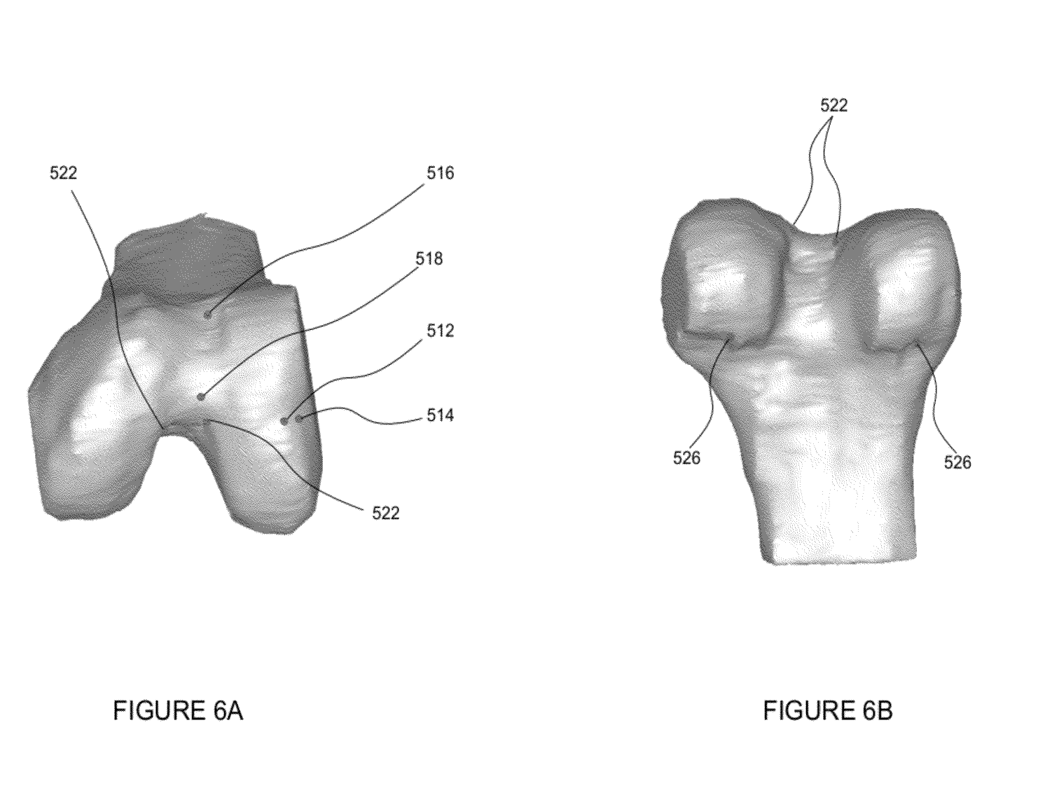

FIGS. 6A and 6B illustrate 3D shaded renderings of the femur and landmarks of FIG. 5.

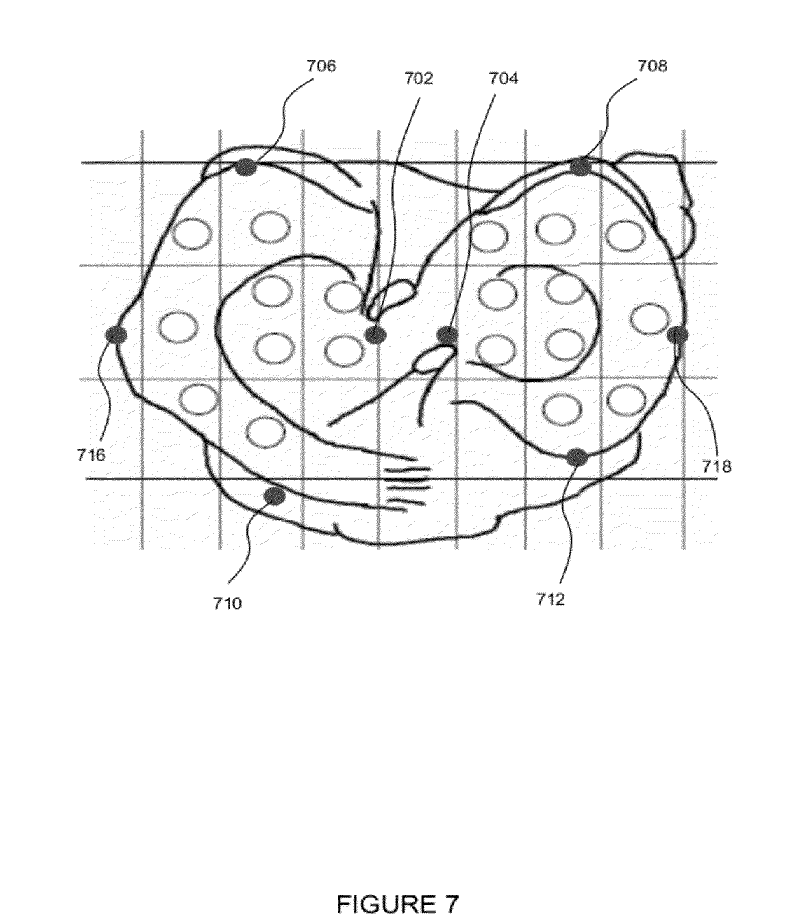

FIG. 7 illustrates a line drawing of cartilage of a tibia overlaid with one embodiment regions and their defining landmarks. The main landmarks used for division into the illustrated regions are the tibial spines and the most anterior, posterior, medial, and lateral points on the tibial plateaus. The medial tibial plateau is divided into nine regions as is the lateral tibial plateau. First and second landmarks 702, 704 are located along the medial and lateral tibial spine and define inside edges of each of the nine regions of the medial tibial plateau and the lateral tibial plateau. A posterior border of the regions is defined by a posteromedial tibial landmark 706 and a posterolateral tibial landmark 708. An anterior border of the regions is defined by an anteromedial tibial landmark 710 and an anterolateral tibial landmark 712. The medial border of the medial tibial plateau is defined by a medial tibial landmark 716 and the lateral border of the lateral tibial plateau is defined by a lateral tibial landmark 718.

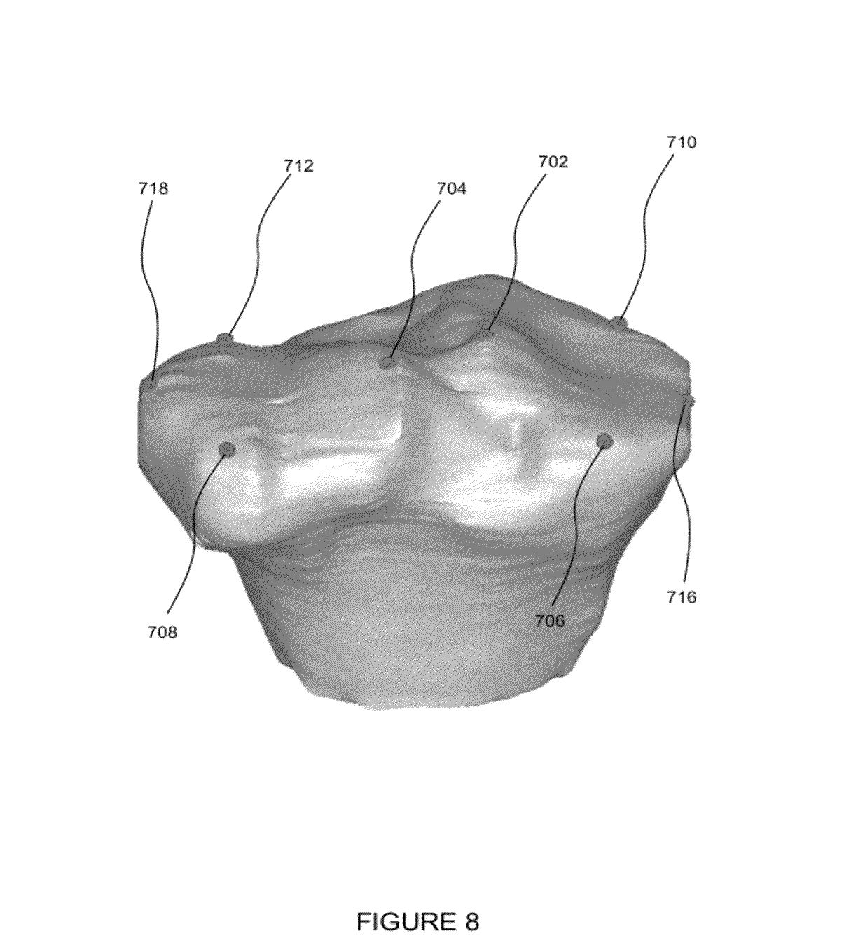

FIG. 8 illustrates a 3D shaded rendering of the tibia and landmarks of FIG. 7.

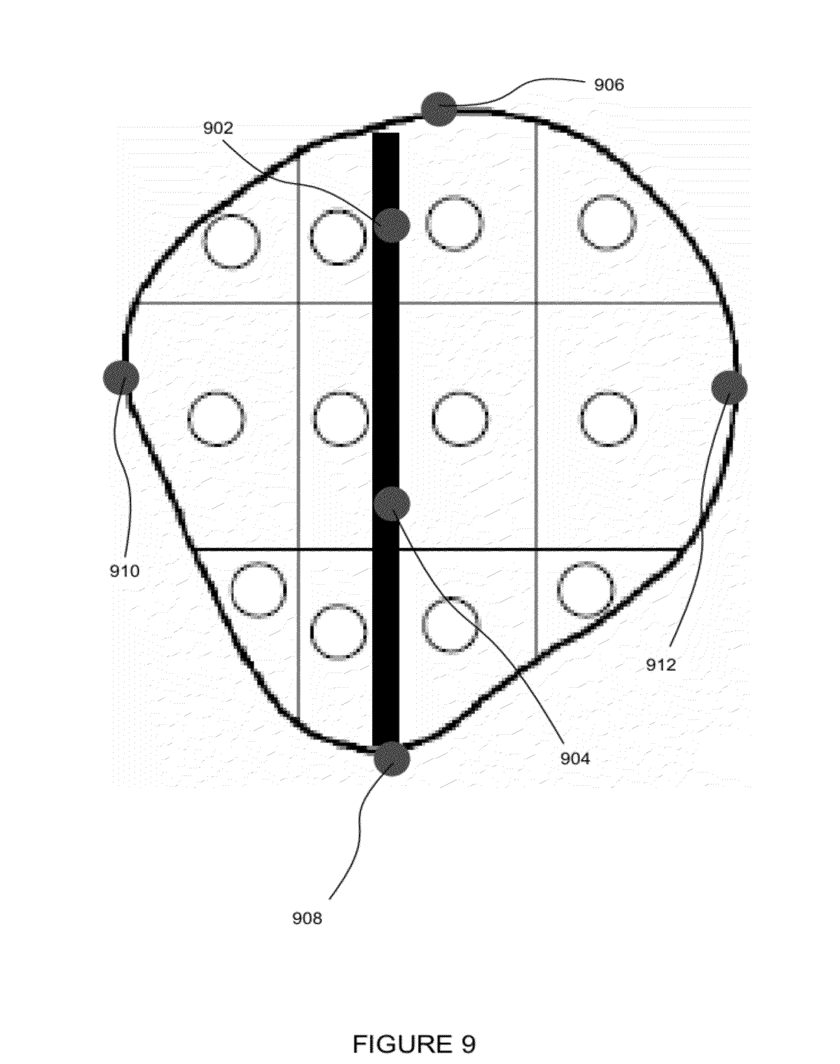

FIG. 9 illustrates a line drawing of cartilage of a back of a patella overlaid with one embodiment regions and their defining landmarks. The main landmarks used for division into the illustrated regions are the patellar ridge, the medial and lateral borders, the superior border, and the most inferior point of patellar cartilage (there is a change in the slope of the bone at this point). The patellar ridge is used to separate medial and lateral facets. In particular, a superior patellar ridge landmark 902 and an inferior patellar ridge landmark 904 are used to identify the patellar ridge. Each facet is then divided into six regions, for instance by dividing each facet into thirds along medial-to-lateral lines and into halves along superior-to-inferior lines. A superior border of the regions is defined by a superior patella landmark 906, an inferior border of the regions is defined by an inferior cartilage landmark 908, the medial border of the regions is defined by a medial patella landmark 910, and a lateral border of the regions is defined by a lateral patella landmark 912.

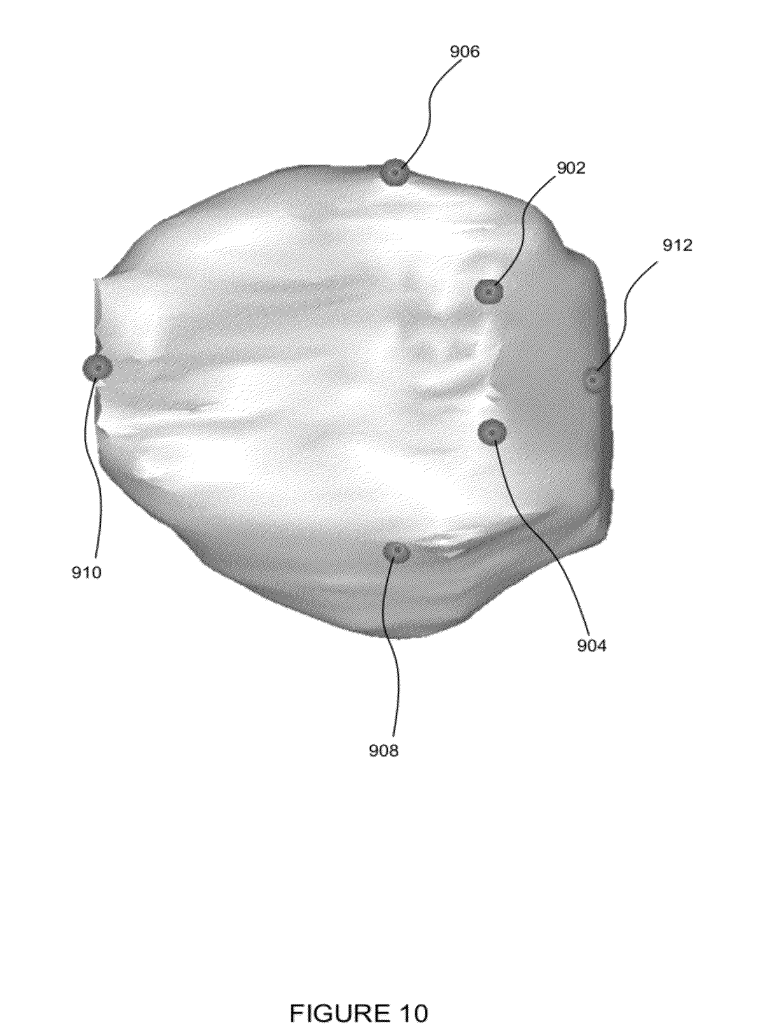

FIG. 10 illustrates a 3D shaded rendering of the patella and landmarks of FIG. 9.

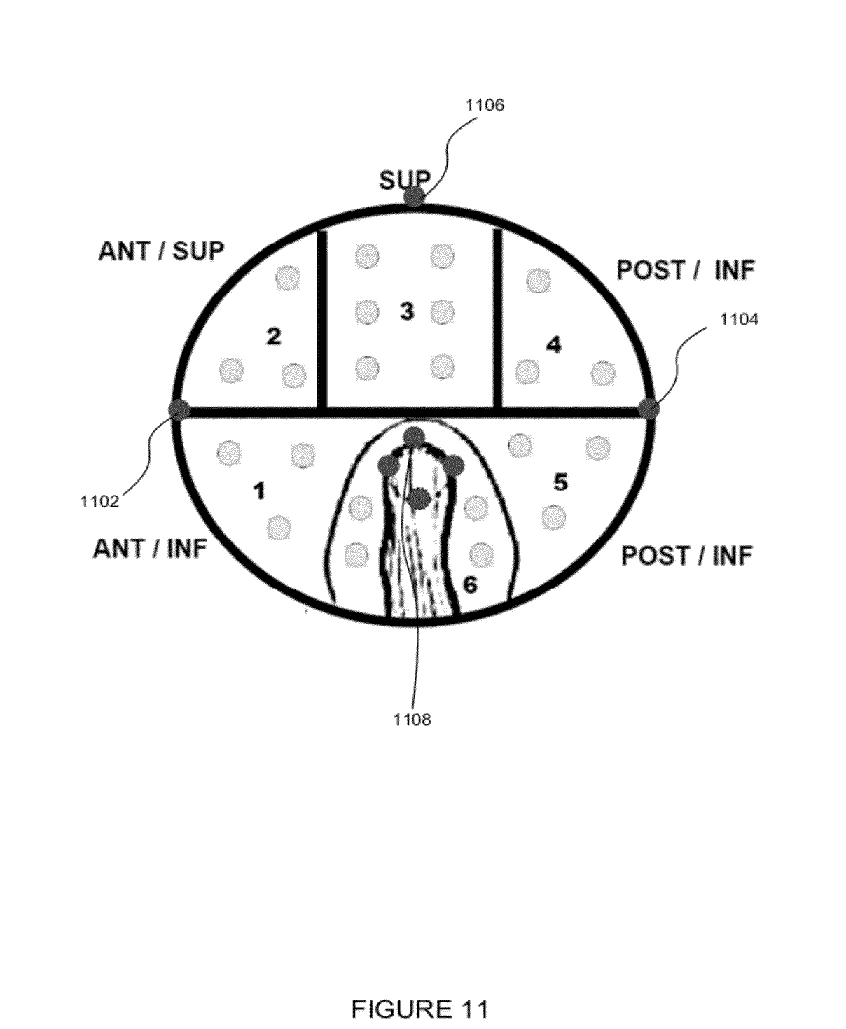

FIG. 11 illustrates a line drawing of cartilage of a femoral head of the hip overlaid with one embodiment of regions and their defining landmarks. The main landmarks used for division into these regions are medial, lateral, superior, and inferior points on the fovea and on the femoral neck. The femoral head is split into six regions, with a first region 1, a second region 6, and a fifth region 5 on an inferior portion of the femoral head, and a second region 2, a third region 3, and a fourth region 4 being on the superior portion of the femoral head. The inferior and superior portions are separated by a line between a center of the fovea and a landmark 1102 on the anterior femoral neck and a landmark 1104 on the posterior femoral neck. The anterior and posterior were separated with a plane between a landmark 1110 on the superior neck, a landmark of the central fovea 1108, and a landmark on the inferior neck 1106. Using this plane, the superior and inferior cartilage was divided into thirds in the anterior-posterior direction.

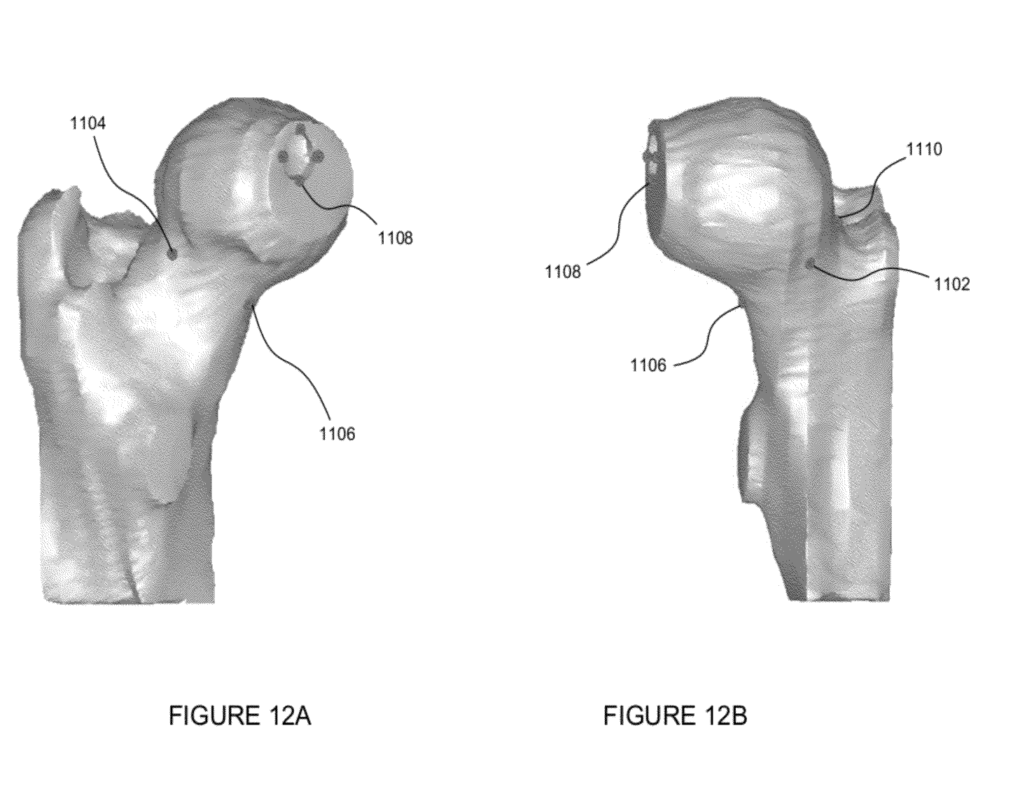

FIGS. 12A and 12B illustrate a 3D shaded rendering of the femoral head of the hip and landmarks of FIG. 11.

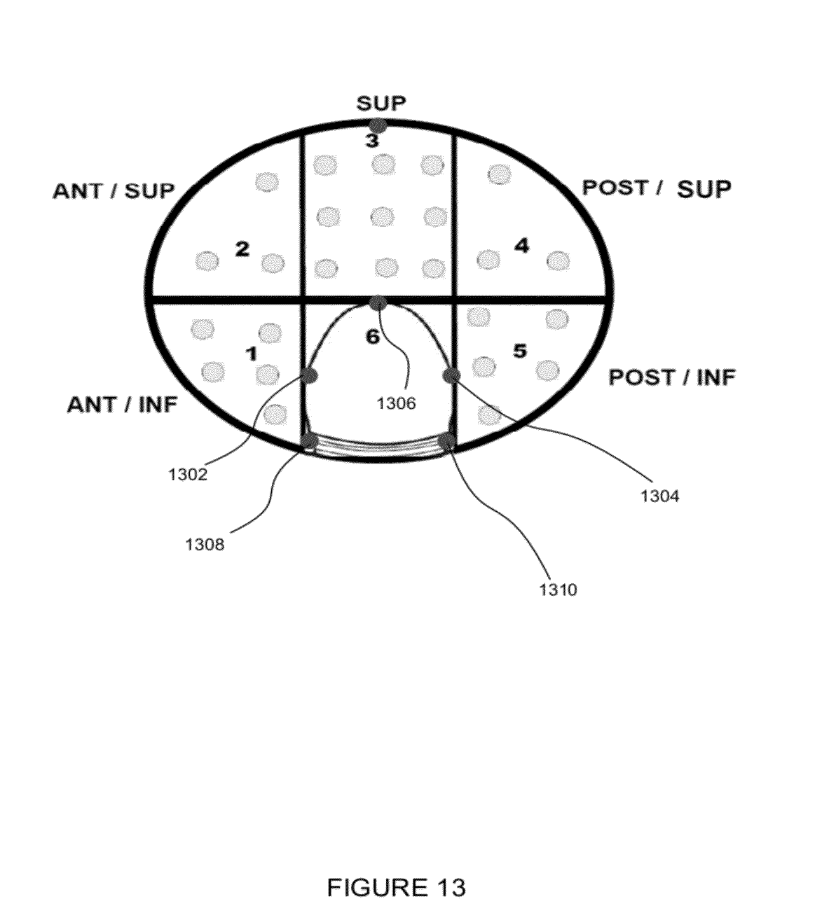

FIG. 13 illustrates a line drawing of cartilage of an inside of the acetabulum overlaid with one embodiment of regions and their defining landmarks. The main landmarks used for division into the illustrated regions are an anterior landmark 1302 of the fossa, a posterior landmark of the fossa 1304, a superior landmark 1306 of the fossa, an anterior insertion landmark 1308 of the transverse ligament, and a posterior insertion landmark 1310 of the transverse ligament. The superior region (including a second region 2, a third region 3, and a fourth region 4) is separated from inferior region (including a first region 1, a sixth region 6, and a fifth region 5) along a line intersecting the superior landmark 1306 of the fossa. The first and second regions 1, 2 are separated from the third and sixth regions 3, 6 via a line passing from the superior to the inferior and passing through or near the anterior landmark 1302 of the fossa and the anterior insertion landmark 1308. The fourth and fifth regions 4, 5 are separated from the third and sixth regions 3, 6 via a line passing from the superior to the inferior and passing through or near the posterior landmark of the fossa 1304 and the posterior insertion landmark 1310.

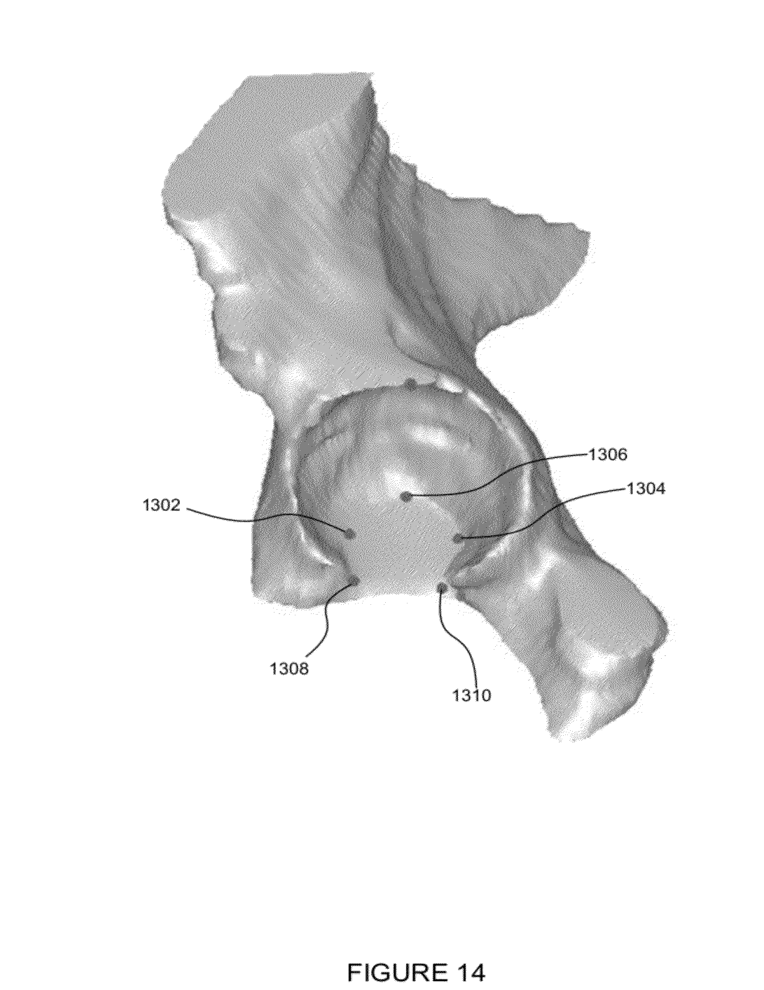

FIG. 14 illustrates a 3D shaded rendering of the acetabulum and landmarks of FIG. 13.

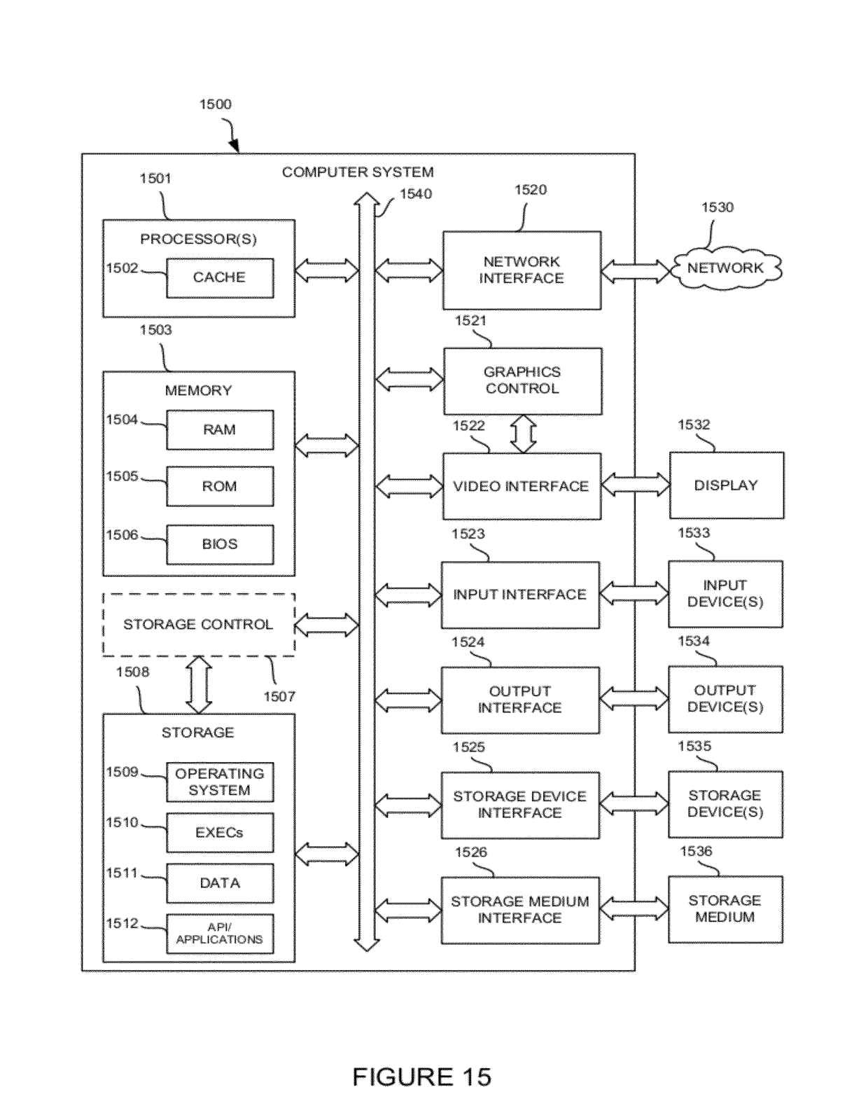

The systems and methods described herein can be implemented in a machine such as a computer system in addition to the specific physical devices described herein. FIG. 15 shows a diagrammatic representation of one embodiment of a machine in the exemplary form of a computer system 1500 within which a set of instructions can execute for causing a device to perform or execute any one or more of the aspects and/or methodologies of the present disclosure. The components in FIG. 15 are examples only and do not limit the scope of use or functionality of any hardware, software, embedded logic component, or a combination of two or more such components implementing particular embodiments.

Computer system 1500 may include a processor 1501 (e.g., 116), a memory 1503 (e.g., 114), and a storage 1508 that communicate with each other, and with other components, via a bus 1540. The bus 1540 may also link a display 1532 (e.g., 112), one or more input devices 1533 (which may, for example, include a keypad, a keyboard, a mouse, a stylus, etc.) (e.g., 110), one or more output devices 1534, one or more storage devices 1535, and various tangible storage media 1536. All of these elements may interface directly or via one or more interfaces or adaptors to the bus 1540. For instance, the various tangible storage media 1536 can interface with the bus 1540 via storage medium interface 1526. Computer system 1500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 1501 (or central processing unit(s) (CPU(s))) optionally contains a cache memory unit 1502 for temporary local storage of instructions, data, or computer addresses. Processor(s) 1501 are configured to assist in execution of computer readable instructions. Computer system 1500 may provide functionality as a result of the processor(s) 1501 executing software embodied in one or more tangible computer-readable storage media, such as memory 1503, storage 1508, storage devices 1535, and/or storage medium 1536. The computer-readable media may store software that implements particular embodiments, and processor(s) 1501 may execute the software. Such instructions and software may be configured to perform MRI sequences, select tissues or organs of interest, define segment masks, select regions of interest, select zones of interest, define region masks, define zone masks, and others operations. Memory 1503 may read the software from one or more other computer-readable media (such as mass storage device(s) 1535, 1536) or from one or more other sources through a suitable interface, such as network interface 1520. The software may cause processor(s) 1501 to carry out one or more processes or one or more steps of one or more processes described or illustrated herein (e.g., define segment mask operation 410 and select region(s)/zone(s) of interest operation 416, to name two non-limiting examples). Carrying out such processes or steps may include defining data structures stored in memory 1503 and modifying the data structures as directed by the software.

The memory 1503 may include various components (e.g., machine readable media) including, but not limited to, a random access memory component (e.g., RAM 1504) (e.g., a static RAM “SRAM”, a dynamic RAM “DRAM, etc.), a read-only component (e.g., ROM 1505), and any combinations thereof. ROM 1505 may act to communicate data and instructions unidirectionally to processor(s) 1501, and RAM 1504 may act to communicate data and instructions bidirectionally with processor(s) 1501. ROM 1505 and RAM 1504 may include any suitable tangible computer-readable media described below. In one example, a basic input/output system 1506 (BIOS), including basic routines that help to transfer information between elements within computer system 1500, such as during start-up, may be stored in the memory 1503.

Fixed storage 1508 is connected bidirectionally to processor(s) 1501, optionally through storage control unit 1507. Fixed storage 1508 provides additional data storage capacity and may also include any suitable tangible computer-readable media described herein. Storage 1508 may be used to store operating system 1509, EXECs 1510 (executables), data 1511, API applications 1512 (application programs), and the like. Often, although not always, storage 1508 is a secondary storage medium (such as a hard disk) that is slower than primary storage (e.g., memory 1503). Storage 1508 can also include an optical disk drive, a solid-state memory device (e.g., flash-based systems), or a combination of any of the above. Information in storage 1508 may, in appropriate cases, be incorporated as virtual memory in memory 1503.

In one example, storage device(s) 1535 may be removably interfaced with computer system 1500 (e.g., via an external port connector (not shown)) via a storage device interface 1525. Particularly, storage device(s) 1535 and an associated machine-readable medium may provide nonvolatile and/or volatile storage of machine-readable instructions, data structures, program modules, and/or other data for the computer system 1500. In one example, software may reside, completely or partially, within a machine-readable medium on storage device(s) 1535. In another example, software may reside, completely or partially, within processor(s) 1501.

Bus 1540 connects a wide variety of subsystems. Herein, reference to a bus may encompass one or more digital signal lines serving a common function, where appropriate. Bus 1540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1500 may also include an input device 1533. In one example, a user of computer system 1500 may enter commands and/or other information into computer system 1500 via input device(s) 1533. For instance, a user may select a tissue or organ of interest via the input device(s) 1533. Examples of an input device(s) 1533 include, but are not limited to, an alpha-numeric input device (e.g., a keyboard), a pointing device (e.g., a mouse or touchpad), a touchpad, a drawing pad, a joystick, a gamepad, an audio input device (e.g., a microphone, a voice response system, etc.), an optical scanner, a video or still image capture device (e.g., a camera), and any combinations thereof. Input device(s) 1533 may be interfaced to bus 1540 via any of a variety of input interfaces 1523 (e.g., input interface 1523) including, but not limited to, serial, parallel, game port, USB, FIREWIRE, THUNDERBOLT, or any combination of the above.

In particular embodiments, when computer system 1500 is connected to network 1530, computer system 1500 may communicate with other devices, specifically mobile devices and enterprise systems, connected to network 1530. For instance, the computing system 104 of FIG. 4 may communicate with the MRI 102 via a network such as network 1530. Communications to and from computer system 1500 may be sent through network interface 1520. For instance, both the MRI 102 and the computing system 104 may include a network interface such as network interface 1520. As another example, network interface 1520 may receive incoming communications (such as requests or responses from other devices) in the form of one or more packets (such as Internet Protocol (IP) packets) from network 1530, and computer system 1500 may store the incoming communications in memory 1503 for processing. Computer system 1500 may similarly store outgoing communications (such as requests or responses to other devices) in the form of one or more packets in memory 1503 and communicated to network 1530 from network interface 1520. Processor(s) 1501 may access these communication packets stored in memory 1503 for processing.

Examples of the network interface 1520 include, but are not limited to, a network interface card, a modem, and any combination thereof. Examples of a network 1530 or network segment 1530 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 1530, may employ a wired and/or a wireless mode of communication. In general, any network topology may be used.

Information and data can be displayed through a display 1532. Three-dimensional renderings of the subset of biochemical MRI voxels can be rendered to the display 1532, for instance, as well as depictions of data generated by the quantitative analysis sub module 138. Examples of a display 1532 include, but are not limited to, a liquid crystal display (LCD), an organic liquid crystal display (OLED), a cathode ray tube (CRT), a plasma display, and any combinations thereof. The display 1532 can interface to the processor(s) 1501, memory 1503, and fixed storage 1508, as well as other devices, such as input device(s) 1533, via the bus 1540. The display 1532 is linked to the bus 1540 via a video interface 1522, and transport of data between the display 1532 and the bus 1540 can be controlled via the graphics control 1521.

In addition to a display 1532, computer system 1500 may include one or more other peripheral output devices 1534 including, but not limited to, an audio speaker, a printer, and any combinations thereof. Such peripheral output devices may be connected to the bus 1540 via an output interface 1524. Examples of an output interface 1524 include, but are not limited to, a serial port, a parallel connection, a USB port, a FIREWIRE port, a THUNDERBOLT port, and any combinations thereof.

In addition or as an alternative, computer system 1500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A processing module operating on a processor of a computing system and reading from and writing to a memory of the computing system, the processing module comprising:
a first selection sub module configured to select a tissue or organ of interest;
a segment mask sub module configured to define a segment mask as a subset of anatomical MRI voxels corresponding to the tissue or organ of interest;
an alignment sub module configured to align three-dimensional positions of the biochemical MRI voxels with three-dimensional positions of the anatomical MRI voxels;
an identification sub module configured to identify a subset of the biochemical MRI voxels having the same three-dimensional positions as the subset of the anatomical MRI voxels; and
a quantitative analysis sub module configured to generate a quantitative description of at least a portion of the subset of the biochemical MRI voxels.

2. The processing module of claim 1, further comprising a 3D rendering sub module configured to render a 3D model of at least a portion of the subset of the biochemical MRI voxels to a display.

3. The processing module of claim 2, wherein the 3D rendering sub module is configured to render the 3D model of the subset of the biochemical MRI voxels to the display overlaid atop at least a portion of the anatomical MRI voxels.

4. The processing module of claim 1, further comprising a second selection sub module.

5. The processing module of claim 4, further comprising a region/zone mask sub module.

6. The processing module of claim 5, wherein the second selection sub module is configured to select one or more regions or zones of interest.

7. The processing module of claim 5, wherein the region/zone mask sub module is configured to define a region/zone mask as a subset of the subset of biochemical MRI voxels corresponding to a region or zone selected by the second selection sub module.

8. The processing module of claim 7, wherein the 3D rendering sub module is configured to render a 3D model of the subset of the subset of the biochemical MRI voxels to the display.

9. The processing module of claim 8, wherein the subset of the subset of the biochemical MRI voxels are rendered overlaid atop at least a portion of the anatomical MRI voxels.

10. The processing module of claim 5, wherein the region/zone mask sub module defines regions or zones using landmarks of the tissue or organ of interest.

11. The processing module of claim 7, wherein the quantitative analysis sub module is configured to perform quantitative analysis on the subset of the subset of the biochemical MRI voxels.

12. The processing module of claim 1, wherein the processing module is configured for operation specific to one tissue or organ.

13. A method of clinically analyzing a tissue or organ of interest in a patient's body comprising:
receiving anatomical MRI voxels from an anatomical MRI sequence of an MRI;
receiving biochemical MRI voxels from a biochemical MRI sequence of the MRI;
aligning, via a processing module, at least a portion of the anatomical MRI voxels with at least a portion of the biochemical MRI voxels;
selecting a tissue or organ of interest;
identifying, via the processing module, a subset of the biochemical MRI voxels that correspond to the tissue or organ of interest; and
performing quantitative analysis on at least a portion of the subset of the biochemical MRI voxels.

14. The method of claim 13, further comprising storing the quantitative analysis in a memory.

15. The method of claim 14, wherein the quantitative analysis is compared to:
at least one quantitative analysis of the same patient generated at an earlier time; or
at least one quantitative analysis of at least one other patient.

16. The method of claim 13, wherein the performing includes generating a histogram of the subset of the biomechanical MRI voxels.

17. The method of claim 13, wherein the performing includes calculating a volume of tissue or organ within at least a portion of the subset of biochemical MRI voxels.

18. The method of claim 13, wherein the performing includes textural analysis of voxels in the subset of biomechanical MRI voxels.

19. The method of claim 13, further comprising rendering at least a portion of the subset of biochemical MRI voxels, in three dimensions, to a display.

20. The method of claim 13, wherein the biochemical MRI voxels are calibrated against one or more reference substances.

21. A system comprising:
a magnetic resonance imaging scanner configured to:
perform an anatomical MRI sequence;
perform a biochemical MRI sequence;
generate anatomical MRI voxels; and
generate biochemical MRI voxels;
a processing module receiving data from the magnetic resonance imaging scanner, the processing module comprising:
a segment mask sub module configured to:
identify a three-dimensional segment mask of the anatomical MRI voxels as those of the anatomical MRI voxels corresponding to a tissue or organ of interest; and
identify a three-dimensional subset of the biochemical MRI voxels as those of the biochemical MRI voxels corresponding to the tissue or organ of interest;
a quantitative analysis sub module configured to generate a quantitative description of at least a portion of the subset of the biochemical MRI voxels.

22. The system of claim 21, wherein the segment mask sub module is further configured to receive user input to assist in identifying the three-dimensional segment mask.

23. The system of claim 22, wherein the user input is a selection of a tissue or organ of interest.

24. The system of claim 22, wherein the user input is an identification of at least a portion of the anatomical MRI voxels to be identified as part of the three-dimensional segment mask.

25. The system of claim 21, wherein the quantitative analysis sub module is further configured to generate a histogram and analyze a distribution of bins in the histogram.

26. The system of claim 21, wherein processing module generates the anatomical MRI voxels and the biochemical MRI voxels from the data received from the magnetic resonance imaging scanner.

27. The system of claim 21, wherein the data received from the magnetic resonance imaging scanner is the anatomical MRI voxels and the biochemical MRI voxels.

28. A non-transitory, tangible computer readable storage medium, encoded with processor readable instructions to perform a method for clinically analyzing a tissue or organ of interest in a patient's body, the method comprising:
receiving anatomical MRI voxels from an anatomical MRI sequence of an MRI;
receiving biochemical MRI voxels from a biochemical MRI sequence of the MRI;
aligning, via a processing module, at least a portion of the anatomical MRI voxels with at least a portion of the biochemical MRI voxels;
selecting a tissue or organ of interest;
identifying, via the processing module, a subset of the biochemical MRI voxels that correspond to the tissue or organ of interest; and
performing quantitative analysis on the subset of the biochemical MRI voxels.
